(19) United States
(12) Patent Application Publication
(10) Pub. No.: US 2004/0150822 A1
(43) Pub. Date: Aug. 5, 2004

(54) Soldering inspection apparatus

(75) Inventors: Dae-Gon Yu, Suwon-City (KR); Chang-Hyo Kim, Yongin-City (KR); Ji-Hoon Kang, Suwon-City (KR); Sang-Hyuck Joo, Gyeongju-City (KR); Heung-Mo Koo, Yongin-City (KR); Duck-Kyum Kim, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/354,119

(22) Filed: Jan. 30, 2003

(51) Int. Cl. G01N 21/00; G01B 11/00

(52) U.S. Cl. 356/394; 356/237.1

(57) ABSTRACT

A soldering inspection apparatus is configured to allow focus areas of vertical and lateral images to coincide with each other. The apparatus includes an illumination module provided with a plurality of light emitting devices and provided at a top thereof with an opening through which light reflected by the subject passes. The apparatus also includes a first photographing unit to photograph a vertical image of the subject through the opening, a plurality of second photographing units to photograph lateral images of the subject through the opening, and a light path unit disposed between the illumination module and the first and second photographing units, and designed to control a progressing path of the light passed through the opening. The apparatus ensures mechanical rigidity, accurately reconstructs a three dimensional image by allowing focus areas of the vertical and lateral images of the subject to coincide with each other, and easily reduces errors in an arrangement of photographing areas of the vertical and lateral images of the subject.

### BACKGROUND OF THE INVENTION

1. Field of the Invention

The present invention relates to a soldering inspection apparatus, and more particularly, to a soldering inspection apparatus that is capable of allowing focus areas of vertical and lateral images of a subject to coincide with each other.

2. Description of the Related Art

In general, manufacturing procedures of electrical and electronic boards include a process of inspecting a soldered status of parts after the parts are mounted on and reflow-soldered to the board.

FIG. 1 is a schematic view of a conventional soldering inspection apparatus. Referring to FIG. 1, the conventional soldering inspection apparatus includes a photographing unit 10, such as a camera, that photographs a subject 40, an illumination unit 30 that illuminates the subject 40, a reflecting plate 22 that reflects light reflected by the subject 40 to allow the reflected light to enter the photographing unit 10, and a regulation unit 21 that regulates the reflecting angle of the reflecting plate 22.

The conventional soldering inspection apparatus having the above-described construction sets position A of the subject 40 first to obtain a vertical image of the subject 40. Thereafter, the illumination unit 30 is operated after a location of the reflecting plate 22 is adjusted to vertical location A′ by the regulation unit 21. Then the vertical image of the subject 40 is photographed by the photographing unit 10.

Thereafter, a location of the subject 40 is adjusted to position B by transferring the subject 40 to obtain a lateral image of the subject 40. In addition, the location of the reflecting plate 22 is adjusted to location B′ by rotating the reflecting plate 22 by a certain angle through the regulation unit 21. The illumination unit 30 is operated after the reflecting angle of the reflecting plate 22 is adjusted, and then the lateral image of the subject 40 is photographed by the photographing apparatus 10. After the vertical and lateral images of the subject 40 are obtained, a three-dimensional image of the subject 40 is reconstructed based on the obtained vertical and lateral images of the subject 40.

The conventional soldering inspection apparatus goes through a process in which the location of the subject or photographing unit is adjusted and the reflecting angle of the reflecting plate is regulated, so as to obtain the lateral image of the subject after the vertical image of the subject has been obtained. Accordingly, if the adjustment or regulation of the subject or reflecting plate is not precisely controlled, the vertical and lateral images photographed by the photographing apparatus do not coincide with each other. Thus, the conventional soldering inspection apparatus is problematic in that the reconstructed three-dimensional image of the subject is inaccurate.

### SUMMARY OF THE INVENTION

Accordingly, it is an aspect of the present invention to provide a soldering inspection apparatus, which is easily arranged and reconstructs an accurate three dimensional image of a subject by allowing focus areas of vertical and lateral images of the subject to coincide with each other.

Additional aspects and advantages of the invention will be set forth in part in the description which follows and, in part, will be obvious from the description, or may be learned by practice of the invention.

The foregoing and other aspects of the present invention are achieved by providing a soldering inspection apparatus including an illumination module provided with a plurality of light emitting devices and provided at a top thereof with an opening through which light reflected by a subject passes. The soldering inspection apparatus also includes a first photographing unit to photograph a vertical image of the subject through the opening, a plurality of second photographing units to photograph lateral images of the subject through the opening, and a light path unit disposed between the illumination module and the first and second photographing units, designed to control a progressing path of the light passed through the opening.

### BRIEF DESCRIPTION OF THE DRAWINGS

The above and other aspects and advantages of the present invention will become apparent and more appreciated from the following detailed description of the preferred embodiments, taken in conjunction with the accompanying drawings of which:

FIG. 1 is a schematic view of a conventional soldering inspection apparatus;

FIG. 2 is a partially sectional view of a soldering inspection apparatus, according to an embodiment of the present invention;

FIG. 3 is a perspective view of a light path unit of the soldering inspection apparatus of FIG. 2;

FIG. 4 is a top view of the soldering inspection apparatus of FIG. 2;

FIG. 5 is a block diagram of the soldering inspection apparatus of FIG. 2;

FIGS. 6A and 6B are images photographed by the soldering inspection apparatus of FIG. 2; and

FIG. 7 is a schematic flowchart showing an operation of the soldering inspection apparatus of FIG. 2.

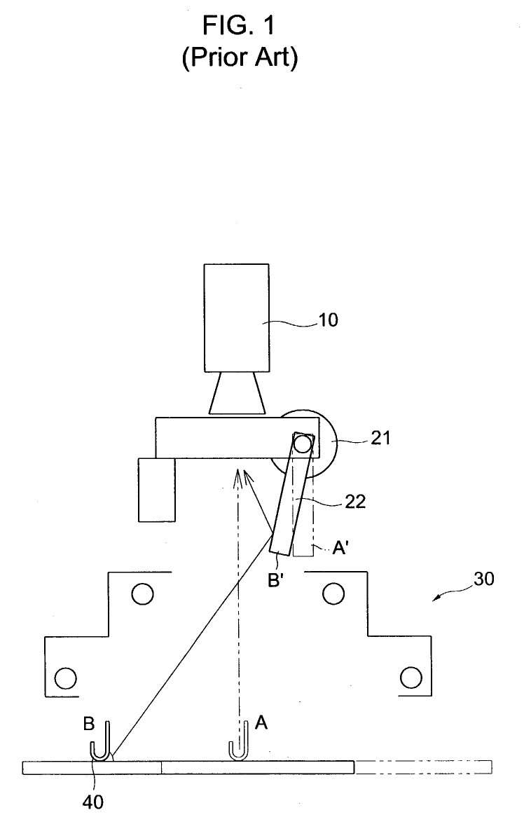

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

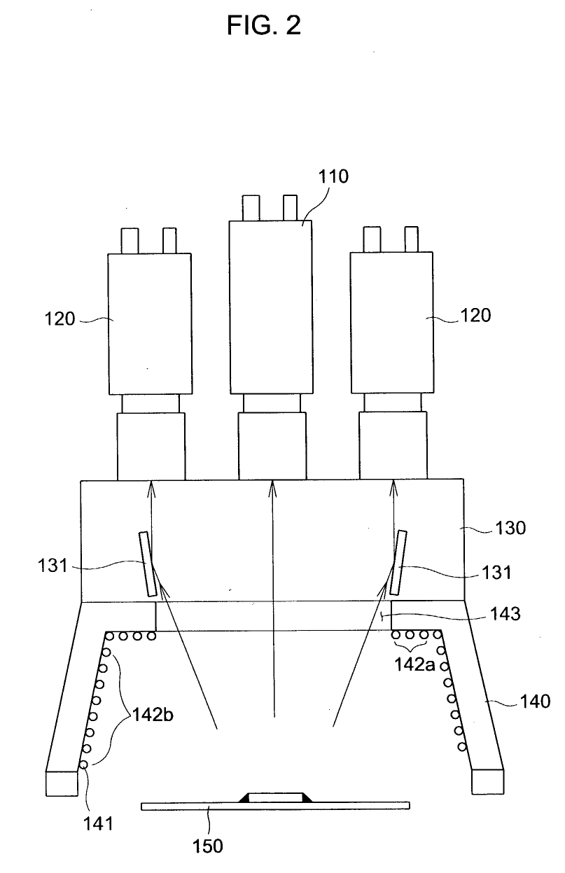

FIG. 2 is a partially sectional view of a soldering inspection apparatus, according to an embodiment of the present invention. Referring to FIG. 2, the soldering inspection apparatus of the present invention includes an illumination module 140, a light path unit 130, a vertical photographing unit 110 (hereinafter, the vertical photographing unit is referred to as a first photographing unit), and a plurality of lateral photographing units 120 (hereinafter, the lateral photographing units are referred to as second photographing units). The illumination module 140 is provided with a plurality of light emitting devices 141 that are individually controlled, and an opening 143 through which light reflected by a subject 150 passes. The light path unit 130 is vertically mounted on the illumination module 140 and controls a progressing path of the light having passed through the opening 143. The first photographing unit 110 is vertically mounted on the light path unit 130 and photographs a vertical image of the subject 150. The second photographing units 120 are all vertically mounted on the light path unit 130 around the first photographing unit 110, and photograph lateral images of the subject 150.

The light path unit 130 passes therethrough light reflected by the subject 150 and progressing through a center portion of the opening 143, while the light path unit 130 guides to the second photographing units 120 light reflected by the subject 150 and progressing through lateral portions of the opening 143. The light path unit 130 is provided with a plurality of reflecting plates 131 to guide the light which progresses through the lateral portions of the opening 143 to the second photographing units 120.

The reflecting plates 131 are mounted below a location in which the second photographing units 120 are mounted, and serve as complete reflectors. The same number of the reflecting plates 31 is equal to the number of the second photographing units 120. The reflecting plates 131 are set to have certain reflecting angles so that a focus area of the vertical image of the subject 150 photographed by the first photographing unit 110 and focus areas of the lateral images of the subject 150 photographed by the second photographing units 120 coincide with each other. In addition, reflecting angles of the reflecting plates 131 are changed to solve non-coincidence of the focus areas of the vertical and lateral images, and the focus areas of the vertical and lateral images are changed according to a distance between the first and second photographing units 110 and 120, and the subject 150.

Accordingly, the second photographing units 120 are vertically and fixedly mounted on the light path unit 130 so that the soldering inspection apparatus has a desired mechanical rigidity. Nevertheless, the second photographing units 120 may obtain lateral images of the subject 150 the same as lateral images which are obtained when the reflecting plates 131 are not existent and the second photographing units 120 are inclined.

The illumination module 140 is constructed in a form of a hemispherical shell or dome-shaped shell. The illumination module 140 is provided at a top thereof with the opening 143 through which light passes. An upper illumination 142a, in which some of the light emitting devices 141 are regularly and circularly arranged in stages, is mounted on an upper surface of inner surfaces of the illumination module 140. In addition, a lateral illumination 142b, in which some of the light emitting devices 141 are regularly and circularly arranged in stages, is mounted on a lateral surface of the inner surfaces of the illumination module 140. The light emitting devices 141 of the upper and lateral illuminations 142a and 142b are not necessarily arranged at the same intervals.

The light emitting devices 141 of the upper and lateral illuminations 142a and 142b are operated in a form of point light sources that each include one or more of the light emitting devices 141. The light emitting devices 141 are variably operated in a range of minimum illuminance to maximum illuminance, as well as operated to be selectively turned on and off.

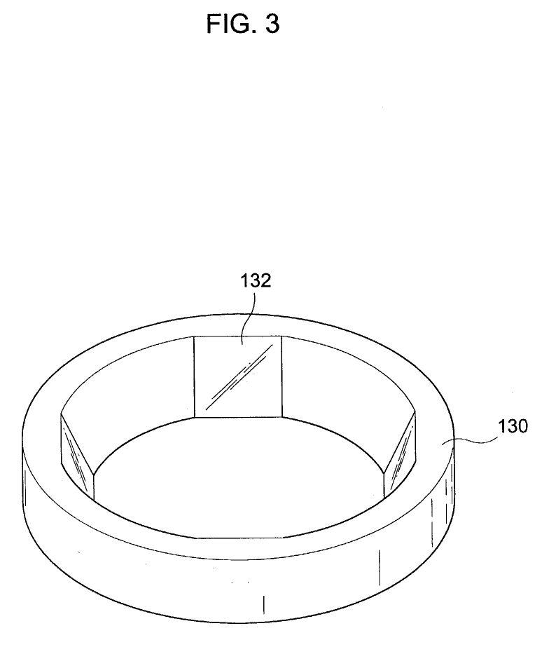

FIG. 3 is a perspective view of a light path unit of the soldering inspection apparatus of FIG. 2. Referring to FIG. 3, a plurality of reflecting surfaces 132, each having a certain reflecting angle, are formed along an inner circumferential surface of the light path unit 130 so that light passing through the lateral portions of the opening 143 is guided to the second photographing units 120.

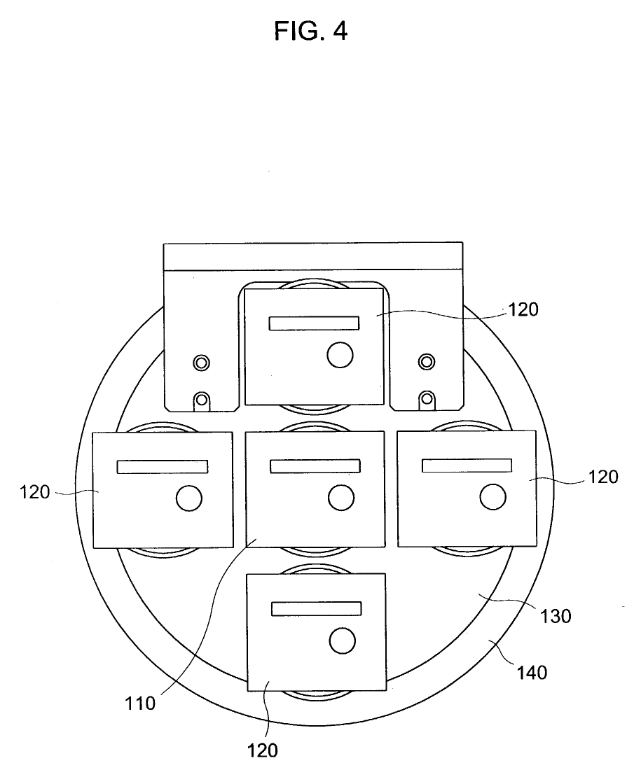

FIG. 4 is a top view of the soldering inspection apparatus of FIG. 2. Referring to FIG. 4, the light path unit 130 is mounted on the illumination module 140, the first photographing unit 110 is mounted on a center portion of a top of the light path unit 130, and the second photographing units 120 are placed in a circle around the first photographing unit 110.

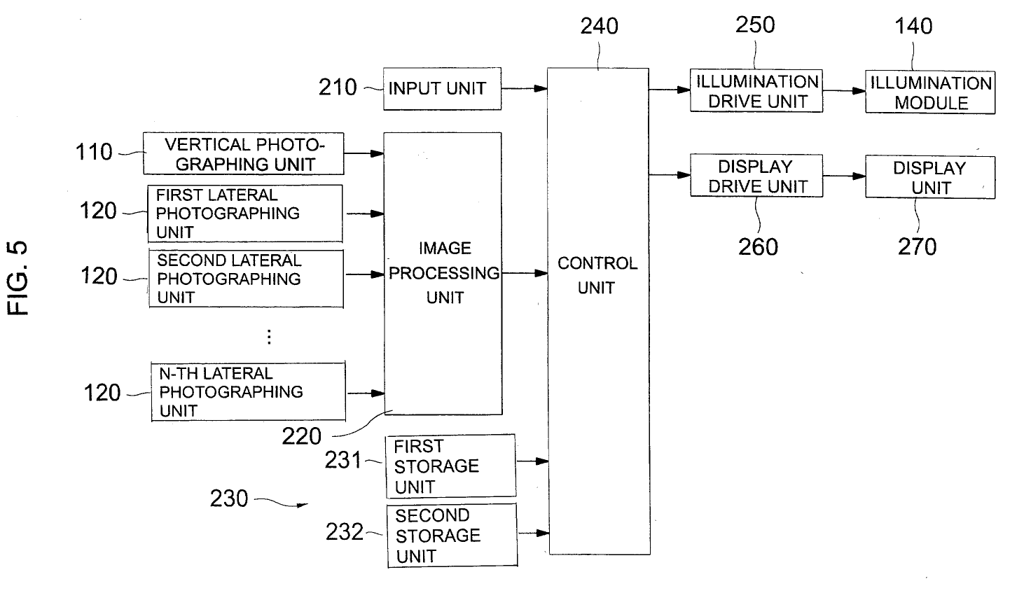

FIG. 5 is a block diagram of the soldering inspection apparatus of FIG. 2. Referring to FIG. 5, the soldering inspection apparatus of includes an input unit 210, an illumination drive unit 250, an image processing unit 220, a control unit 240, a display unit 270 and a display drive unit 260. The input unit 210 inputs data that contains operation commands. The illumination drive unit 250 drives the illumination module 140 provided with the plurality of light emitting devices 141. The image processing unit 220 captures frame images from images photographed by the first and second photographing units 110 and 120, and processes the frame images in a preset manner. The control unit 240 extracts three-dimensional features of the subject 150 from the processed framed image data, and reconstructs a three dimensional image of the subject 150 using the three-dimensional features. The display unit 270 displays the three-dimensional image of the subject 150. The display drive unit 260 drives the display unit 260.

The illumination drive unit 250 drives the light emitting devices 141 of the upper and lateral illuminations 142a and 142b in the form of point light sources that each include one or more of the light emitting devices 141. The light emitting devices 141 are variably operated in the range of the minimum illuminance to the maximum illuminance, as well as operated to be selectively turned on and off.

The soldering inspection apparatus includes a storage unit 230 to store data. The storage unit 230 includes a first storage unit 231 to store programs relating to overall operations of the soldering inspection apparatus, and a second storage unit 232 to store data relating to image processing.

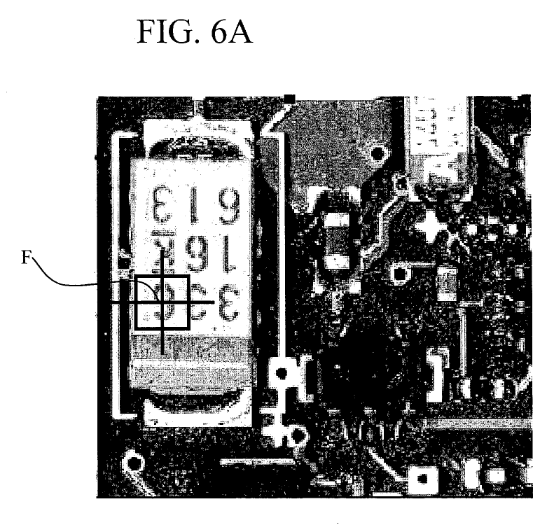

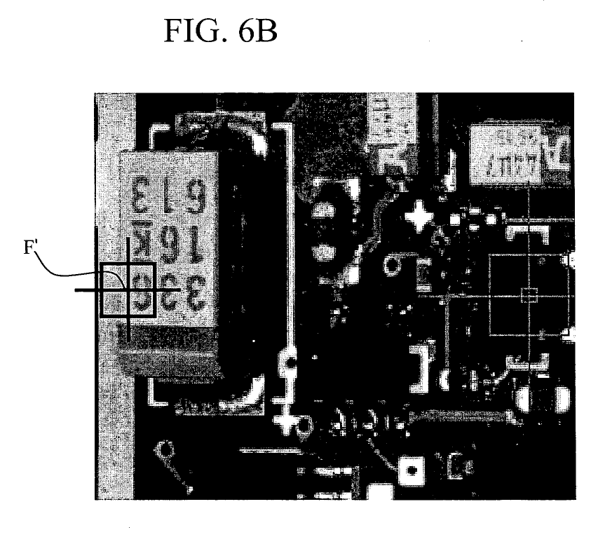

FIGS. 6A and 6B are images photographed by the soldering inspection apparatus of FIG. 2. FIG. 6A is a vertical image of a subject photographed by the first photographing unit 110. FIG. 6B is a lateral image of the subject photographed by one of the second photographing units 120. As shown in FIGS. 6A and 6B, it will be appreciated that focus areas F (see FIG. 6A) and F′ (see FIG. 6B) of the vertical and lateral images coincide with each other.

Hereinafter, there is described an operation of the soldering inspection apparatus of the present invention.

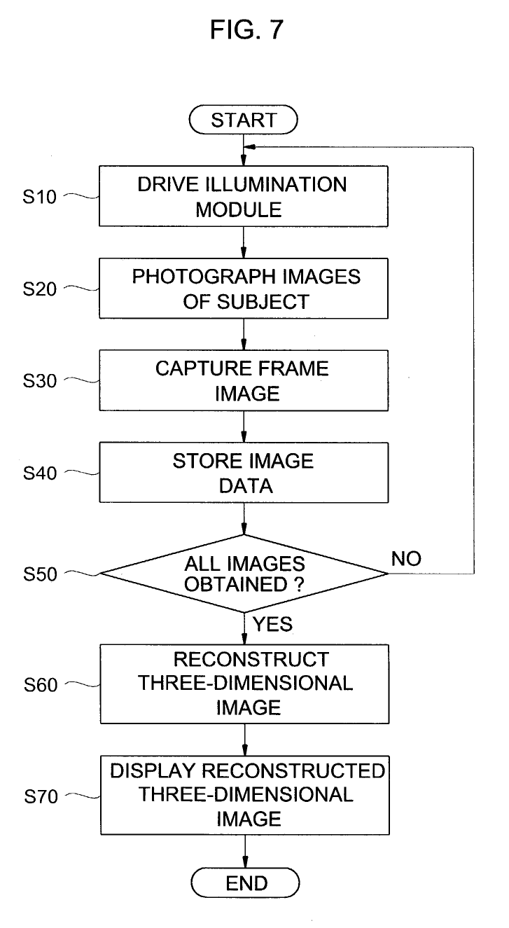

FIG. 7 is a schematic flowchart showing an operation of the soldering inspection apparatus of FIG. 2. Referring to FIG. 7, the control unit 240 controls the illumination drive unit 250 to drive the upper and lateral illuminations 142a and 142b of the illumination module 140 in order to photograph the subject 150 at operation S10. The first photographing unit 110 and the second photographing units 120 photograph the vertical and lateral images of the subject 150, respectively, as shown in FIGS. 6A and 6B, at operation S20. Here, the focus areas of the vertical and lateral images coincide with each other.

The image processing unit 220 captures frame images from the vertical and lateral images photographed by the first photographing unit 110 and the second photographing unit 120, performs the image processing of the frame images, and transmits the processed frame images to the control unit 240 at operation S30. The control unit 240 stores image data transmitted from the image processing unit 220 to the second storage unit 232 at operation S40.

The control unit 240 determines whether all the vertical and lateral images of the subject 150 are obtained at operation S50. If not all the vertical and lateral images of the subject 150 are obtained at operation S50, the control unit 240 repeats the operations S10 to S40, thereby obtaining all the vertical and lateral images of the subject 150.

If all the vertical and lateral images of the subject 150 are obtained at operation S50, the control unit 240 reconstructs the three-dimensional image of the subject 150 based on the image data stored in the second storage unit 232 at operation S60. The control unit 240 controls the display drive unit 260 so that the display unit 270 displays the reconstructed three-dimensional image of the subject 150. Accordingly, a photographer is able to determine whether soldering of the subject 150 is defective by observing the image displayed on the display unit 270.

As described above, the first photographing unit that photographs the vertical image of the subject and the second photographing units that photograph the lateral images of the subject are vertically and fixedly positioned at preset locations, so the focus areas of the vertical and lateral images are allowed to coincide with each other. In addition, the reflecting angles of the reflecting plates provided to the light path unit are regulated, so that the photographing areas of the first and second photographing units are easily arranged. Thus, even though errors of arrangement of the photographing areas occur, the photographing areas are easily arranged by regulating the reflecting plates without changing the locations of the first and second photographing units.

As apparent from the above description, the present invention provides a soldering inspection apparatus, which may ensure mechanical rigidity, accurately reconstruct a three dimensional image by allowing focus areas of the vertical and lateral images of the subject to coincide with each other, and easily reduce errors in the arrangement of the photographing areas of the vertical and lateral images of the subject.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A soldering inspection apparatus to photograph a subject and to reconstruct a three dimensional image of the subject, comprising:
an illumination module provided with a plurality of light emitting devices and provided at a top thereof with an opening through which light reflected by the subject passes;
a first photographing unit to photograph a vertical image of the subject through the opening;
a plurality of second photographing units to photograph lateral images of the subject through the opening; and
a light path unit disposed between the illumination module and the first and second photographing units, to control a progressing path of the light passed through the opening.

2. The apparatus as set forth in claim 1, wherein said first photographing unit is vertically mounted on the light path unit, and said second photographing units are vertically placed in a circle around the first photographing unit.

3. The apparatus as set forth in claim 1, wherein said illumination module has an open bottom to cover the subject and comprises:
an upper illumination mounted on an upper surface of inner surfaces of the illumination module and includes at least one of the light emitting devices regularly and circularly arranged in stages; and
a lateral illumination mounted on a lateral surface of the inner surfaces of the illumination module and includes at least one of the light emitting devices regularly and circularly arranged in stages.

4. The apparatus as set forth in claim 1, wherein said light path unit passes therethrough light reflected by the subject and progressing through a center portion of the opening, and includes a plurality of reflecting plates to guide light progressing through lateral portions of the opening to the second photographing units.

5. The apparatus as set forth in claim 4, wherein said reflecting plates are positioned below the second photographing units to have preset reflecting angles so that focus areas of the vertical and lateral images of the subject photographed by the first and second photographing units coincide with each other, a number of the reflecting plates being equal to a number of second photographing units, and the reflecting angles of the reflecting plates configured to be regulated.

6. The apparatus as set forth in claim 1, wherein said light path unit passes therethrough light reflected by the subject and progressing through a center portion of the opening, and includes a plurality of reflecting surfaces to guide light passing through lateral portions of the opening to the second photographing units, the reflecting surfaces being formed along an inner circumferential surface of the light path unit to have certain reflecting angles, a number of the reflecting surfaces being equal to a number of the second photographing units.

7. A method of controlling a soldering inspection apparatus provided with first and second photographing units, comprising:
photographing vertical and lateral images of a subject with focus areas of the vertical and lateral images coinciding with each other, using the first and second photographing units;
capturing frame images from the vertical and lateral images photographed by the first and second photographing units; and
reconstructing a three-dimensional image of the subject based on the frame images.

8. The method as set forth in claim 7, further comprising:
regulating illuminance of the subject before photographing the vertical and lateral images of the subject.

9. The method as set forth in claim 7, further comprising:
storing the captured frame images and extracting the stored frame images before reconstructing the three-dimensional image of the subject.

10. An inspection method of soldering using first and second photographing units, comprising:
photographing vertical and lateral images of a subject with focus areas of the vertical and lateral images coinciding with each other, using the first and second photographing units;
capturing frame images from the vertical and lateral images photographed by the first and second photographing units;
reconstructing a three-dimensional image of the subject based on the frame images; and
estimating soldering quality of the subject through the reconstructed three-dimensional image.

11. The method as set forth in claim 10, further comprising:
regulating illuminance of the subject before photographing the vertical and lateral images of the subject.

12. The method as set forth in claim 10, further comprising:
storing the captured frame images and extracting the stored frame images before reconstructing the three-dimensional image of the subject.

13. A soldering inspection apparatus to photograph a subject and to reconstruct a three dimensional image of the subject, comprising:
an illumination module including a plurality of light emitting devices;
first and second photographing units to photograph vertical images and lateral images of the subject, respectively;
an input unit to input data containing operation commands;
an illumination drive unit to drive the illumination module provided with the plurality of light emitting devices;
an image processing unit to capture frame images from images photographed by the first and second photographing units, and to process the frame images in a preset manner;
a control unit to extract three-dimensional features of the subject from the processed framed image data, and to reconstruct the three dimensional image of the subject using the three-dimensional features; and
a display unit to display the three-dimensional image of the subject.

14. The apparatus as set forth in claim 13, wherein said illumination module comprises:
an upper illumination mounted on an upper surface of inner surfaces of the illumination module and includes at least one of the light emitting devices regularly and circularly arranged in stages; and
a lateral illumination mounted on a lateral surface of the inner surfaces of the illumination module and at least one of the light emitting devices regularly and circularly arranged in stages.

15. The apparatus as set forth in claim 13, wherein the light emitting devices are variably operated in a range of minimum to maximum illuminance, and are selectively turned on and off.

16. The apparatus as set forth in claim 13, further comprising:
a first storage unit to store programs relating to overall operations of the soldering inspection apparatus; and
a second storage unit to store data relating to image processing performed by the image processing unit.
